(19) United States
(12) Patent Application Publication
(10) Pub. No.: US 2016/0052169 A1
(43) Pub. Date: Feb. 25, 2016

(54) Portable Asphalt Recycler

(71) Applicants: Vernon E. Baumrind, Charlotte, NC (US); Donald Kevin Pressley, Indian Trail, NC (US)

(72) Inventors: Vernon E. Baumrind, Charlotte, NC (US); Donald Kevin Pressley, Indian Trail, NC (US)

(21) Appl. No.: 14/467,093

(22) Filed: Aug. 25, 2014

(51) Int. Cl. B28C 5/18

(52) U.S. Cl. CPC B28C 5/1818

(57) ABSTRACT

A portable asphalt recycling device comprising: a base; a rotatable drum unit secured to the base; a hopper secured to the rotatable drum unit used to load and unload materials from within the drum unit; a burner secured to the rear of the drum unit to heat the materials; one or more corkscrew fins located within the drum unit, the fins being operable in the mixing and folding of the material and also being operable in pulling the material to the back of the drum unit for complete heating and mixing and pushing the material from the back of the drum unit to the front of the drum unit for unloading; wherein the material within the drum unit does not come into contact with a flame produced by the burner; and a thermostatic heating sensor device located within the drum unit used to measure the temperature of the material.

### CROSS REFERENCE TO RELATED APPLICATIONS

This application claims the benefit of U.S. Provisional Application No. 61/869,895 filed Aug. 26, 2013.

### FIELD OF THE INVENTION

The subject invention relates in general to the field of asphalt pavement recycling, and more particularly to a relatively small machine or Asphalt Pavement Recycler (hereinafter “APR”) that permits an efficient and cost-effective system or method for reprocessing old or reclaimed asphalt pavement from a deteriorated or depleted asphalt paved surface by recycling the used and damaged asphalt at the site of an asphalt repair project by producing a hot asphalt mix which is returned to the same general location of the original asphalt that has been damaged over time.

### BACKGROUND OF THE INVENTION

Cities, towns and counties across America are struggling with a declining road infrastructure that costs more than these governments can afford to maintain and replace with conventional roadway rehabilitation techniques. These communities and counties are focusing more today on the economic value of recycling, with emphasis placed on seeking ways to save money. Asphalt is 100% recyclable and is one of the most abundant recyclables on earth. According to the Environmental Protection Agency and Federal Highway Administration, asphalt pavement is not only America's most recycled and reused material, it now is being recycled and reused at increasing annual rates that are more than twice the combined total for recycled paper, glass, plastic, aluminum and other recyclables, with an upward trend that is expected to continue.

Existing roadway materials are rich in asphalt and aggregate-coated asphalt cement and may be re-used in the reconstruction of deteriorated, worn and debilitated paved roadway surfaces. In-place recycling and pavement preservation programs utilizing asphalt recycling machines save tax dollars by permitting the reprocessing of old asphalt material that is already there in place within the pre-existing material. Currently, the cost of virgin hot asphalt mix from the local asphalt plant approximates $80.00 to $100.00 per ton with the price fluctuating with international petroleum prices. The cost of transporting asphalt from the plant to the job site, in addition to other associated costs and overhead drive the ultimate price of plant asphalt even higher. Cold patch asphalt material can cost $200.00 per ton and more; and, repairs completed with cold patch are temporary, at best. Other alternative materials, such as rubber asphalt pellets containing all the constituents of hot asphalt mix, can cost as much as $600.00 per ton. Asphalt pavement recyclers eliminate the need to secure hot mix from the asphalt plant and allow the paver to utilize existing reclaimed broken, chunk or milled asphalt material already at the site of the needed repair to produce recycled hot asphalt mix at minimal cost.

There are other benefits to society of recycling reclaimed pavement which the recycling machine allows; the machine and process conserves natural resources by reducing the amount of virgin materials required for a mixture and the energy required for extracting, processing and transporting these materials. Recycling reclaimed asphalt pavement conserves millions of barrels of asphalt binder. The ability to recycle old asphalt pavement also allows the diversion of this deteriorated and depleted material from public and private landfills where, if not recycled, it would be placed in and would perpetually consume valuable land space, without any benefit to the economy, the environment or our natural resources.

Reclaimed asphalt pavement constitutes a treasure trove of preprocessed asphalt paving material which, even though aged and depleted to some extent, continues to retain the essential components of asphalt mix. The mix may be simply rejuvenated on site by blending in appropriate rejuvenate agents incorporated with the old reclaimed asphalt pavement processed in the recycling machine.

Pre-existing, but larger, asphalt pavement recycling machines are currently available, but are equipped with accessories and features that are reflected in the cost of these machines ranging from $70,000 to $325,000, making these machines unaffordable by the average paver and smaller, less capitalized communities. The APR machine is a smaller, simpler and downsized, but affordable, in-place asphalt pavement recycler. It's availability in the market permits those who have previously been unable to purchase the more expensive, larger recycling machines to acquire this affordable recycler, allowing the bulk of pavers and communities to take advantage of the savings and, as a result, allowing a larger proportion of this country's needed asphalt pavement repairs to be reclaimed and reprocessed for economical re-use.

Another competitive machine, which primarily functions to produce new hot mix using packaged pre-mix and aggregate operates off of liquefied petroleum (compressed) gas which always represents a danger to the user of the equipment.

Regarding heating of the asphalt material, one competitor's recycling model heats by convection. They have a patented heat plate and drum that doesn't rotate. The material is moved through the drum and the heat is transferred to the material. The RSL recycler has a mixing drum with internal “lifters” and it heats by an internal heat vector system. Another competitor's machine mixes by tumbling the material through a vortex of heat.

The way in which the old material is loaded into the APR of the instant invention and unloaded varies with that of the competitive machines. One competitor's machine has a hydraulic bucket-wide loading hopper that feeds the old material into the machine through the coned opening. In another competitor's machine, the top hopper assembly is manually operated. With the APR, the old asphalt material is loaded into a heavy gage hydraulic hopper that is hinged at the bottom of the dump opening in the mixer drum and, then, the hopper is raised by a hydraulic cylinder, dumping the old asphalt material (and pre-mix rejuvenate, if the operator desires) into the opening of the mixing drum. Serving as a door to secure the material and contain the heat in the drum, the hopper is, then, closed against the drum opening. A hydraulic lift raises the drum for easy unloading directly into the waiting asphalt application.

U.S. Pat. No. 5,848,755 ('420) discloses an asphalt recycling device which includes a load hopper, a conveyer belt, a chute, a drum, a heat source, a material classifier ring, a shutter, and an outlet conveyer. '420 discloses that asphalt material enters load hopper and travels along conveyer belt until it reaches chute. Chute delivers the asphalt material into the drum where the asphalt material is generally granularized by the material classifier ring and by the tumbling action of drum. The asphalt material then exits Asphalt Recycling System through shutter and travels along outlet conveyer. However, '420 does not disclose the inclusion of one or more corkscrew fins or a temperature sensor located within the rotatable drum unit. Additionally, '420 does not disclose the inclusion of a water reservoir or water pump and therefore lacks the ability to process concrete.

U.S. Pat. No. 8,465,225 (225) and U.S. Patent Application No. 2013/0071184 (184) each disclose a portable asphalt recycling and asphalt heat management apparatus comprising a one-piece combustion chamber that defines a fuel incubator disposes within. A heat accumulator is coupled to the combustion chamber and a hopper is coupled to the heat accumulator. The apparatus also includes a heat distribution system in association with the heat accumulator. However, neither '225 nor '184 discloses the inclusion of one or more corkscrew fins or a temperature sensor located within the rotatable drum unit. Additionally, neither '225 nor '184 discloses the inclusion of a water reservoir or water pump and therefore each lacks the ability to process concrete.

Hence, there is clearly a need for an asphalt recycling system which makes up for the deficiencies described above.

### SUMMARY OF THE INVENTION

A portable asphalt recycling device comprising: a base; a rotatable drum unit rotatably secured to the base; a hopper secured to the front of the rotatable drum unit used to load materials into the rotatable drum unit to be recycled and used to unload materials which have been recycled from within the rotatable drum unit; a burner secured to the rear of the rotatable drum unit which is used to heat the materials which are to be recycled; one or more corkscrew fins located within the rotatable drum unit, the fins being operable in the mixing and folding of the material to be recycled and also being operable in: pulling the material to be recycled to the back of the rotatable drum unit for complete heating and mixing and pushing the recycled/rejuvenated material from the back of the rotatable drum unit to the front of the drum unit for unloading; wherein the material within the rotatable drum unit does not come into contact with a flame produced by the burner; and a thermostatic heating sensor device located within the rotatable drum unit used to measure the temperature of the material to be recycled while it is being recycled and or rejuvenated.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a side perspective view of a portable asphalt recycler.

FIG. 2 is a side perspective view of a portable asphalt recycler.

FIG. 3 is a rear view of a portable asphalt recycler.

FIG. 4 is a side view of a portable asphalt recycler.

FIG. 5 is a side view of a portable asphalt recycler.

FIG. 6 is a front view of a portable asphalt recycler in a raised position.

FIG. 7 is a top view of a portable asphalt recycler.

FIG. 8 is a rear view of the inside of the drum unit of a portable asphalt recycler.

FIG. 9 is a rear perspective view of a portable asphalt recycler.

FIG. 10 is a rear perspective view of a portable asphalt recycler.

### DESCRIPTION OF THE INVENTION

The essential function of the Asphalt Pavement Recycler (APR) 5 disclosed herein is for recycling reclaimed asphalt pavement into a hot asphalt material adequate for re-use in refilling and repaving potholes, making utility cut repairs and other small asphalt repairs. The APR 5, as described herein, is the smallest, the most compact and simplest of the existing asphalt pavement recycling machines in the current market; and, due to its affordable price, it provides the most economical means of recycling small amounts of asphalt pavement to the majority of the potential users in the market. Alternately, the APR 5 functions to produce concrete on demand, on the spot.

The rationale for the APR 5 disclosed herein is to provide the means by which the largest segment of the user market (the small asphalt pavers, the small and medium-size communities, utility providers and others who cannot generally afford the larger, more expensive competitive recyclers) can acquire this machine to reduce the cost of repairing asphalt to a minimum. Unlike the larger asphalt recyclers, with prices that the overwhelming majority of users cannot afford, the APR 5 disclosed herein provides the opportunity for everyone, not just the privileged few, to start recycling valuable existing old asphalt instead of wasting this resource and, at the same time, saving substantial dollars that otherwise are typically spent needlessly buying replacement asphalt from the local asphalt plant time after time. The APR 5 provides a money saving alternative to traditional asphalt repairs and it quickly pays for itself, as the APR 5 is able to repair and patch into the future at virtually no cost for paving material because he is not constantly paying for replacement asphalt from the local hot plant repeatedly as has been done traditionally in the past.

The instant invention describes a mobile asphalt pavement recycler (APR) 5 comprising: a base 20, a rotatable drum unit 10 rotatably secured to the base, a hopper or a trough 70 secured to the base or the rotatable drum unit 10 used to load materials (i.e. used and/or new asphalt pavement) into the rotatable drum unit 10 to be processed and used to unload materials which have been processed from within the rotatable drum unit 10, a burner 50 secured to the rear 18 of the rotatable drum unit 10 which is used to heat the materials which are to be recycled. The instant invention also includes one or more fins 65 located within the rotatable drum unit 10, where the fins are operable in the mixing and folding of the material to be recycled/processed and also being operable in pulling the material to be recycled/processed to the rear 18 of the rotatable drum unit for complete heating and mixing and pushing the recycled/processed material from the rear 18 of the rotatable drum unit 10 to the front 16 of the drum unit 10 for unloading, wherein the material within the rotatable drum unit 10 does not come into contact with a flame produced by the burner 50 and a thermostatic heating sensor device located within the rotatable drum unit used to measure the temperature of the material to be recycled while it is being recycled.

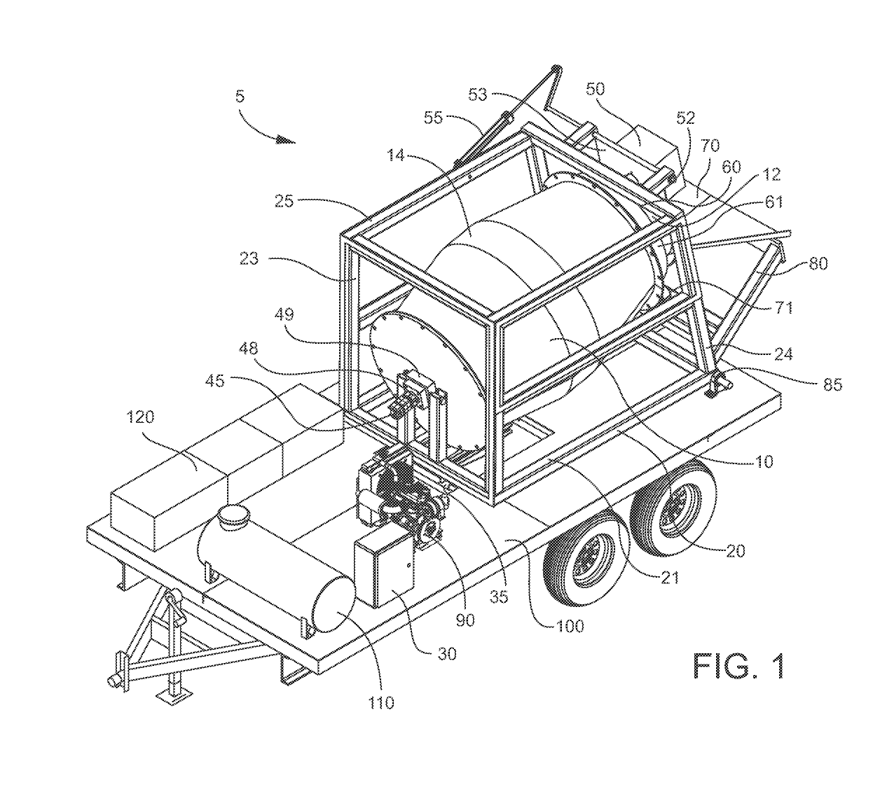

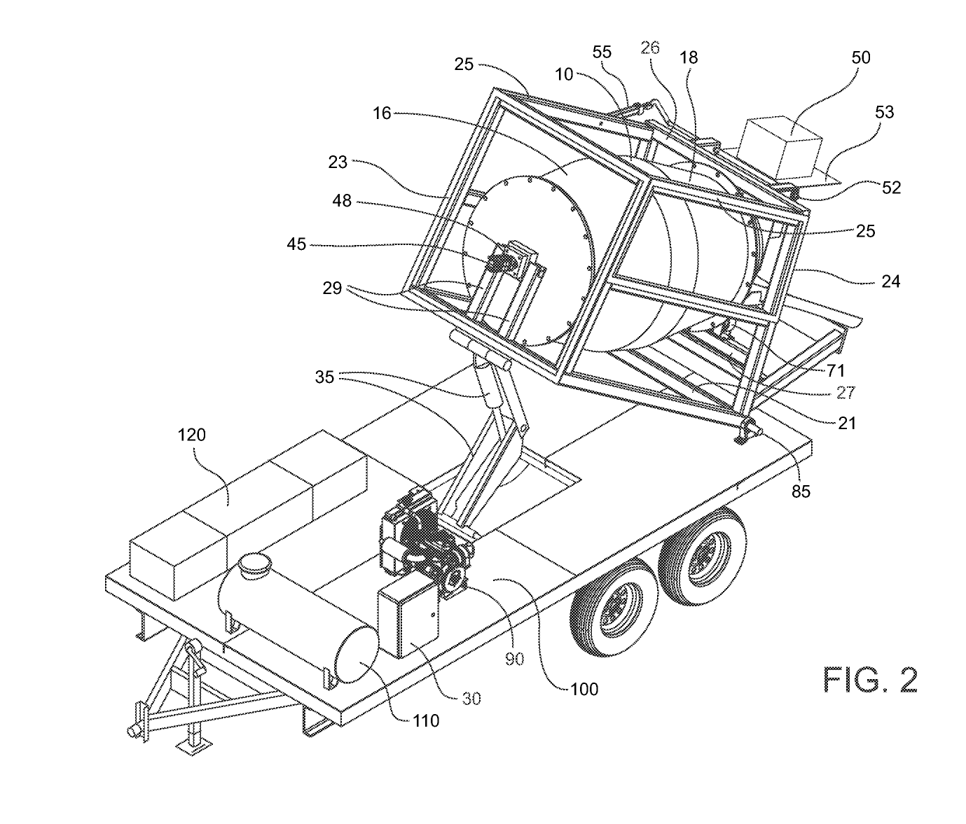

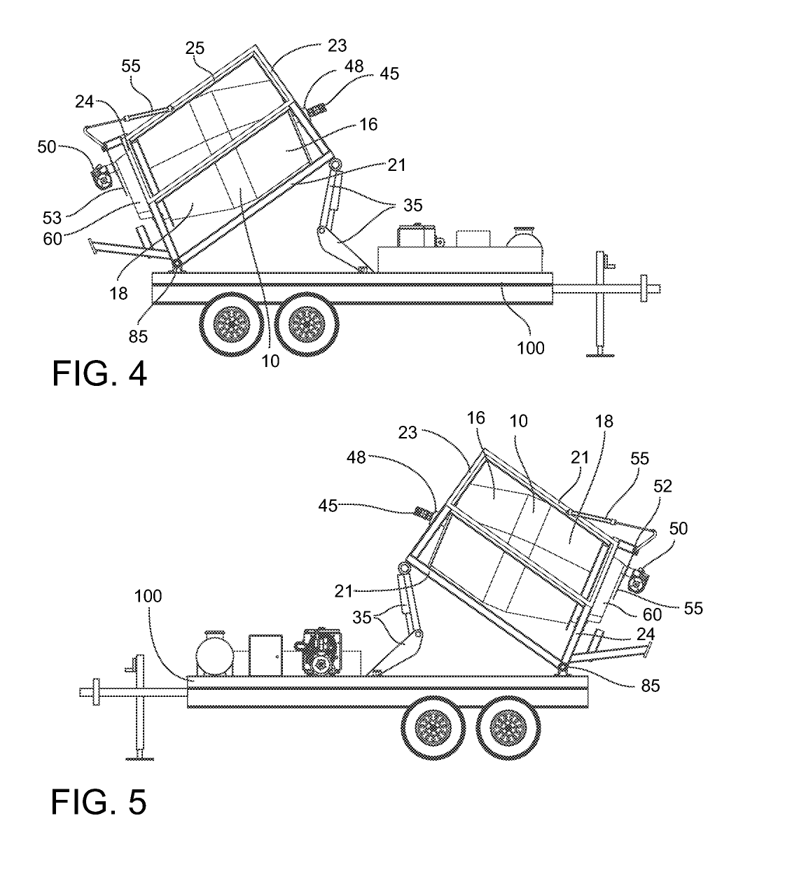

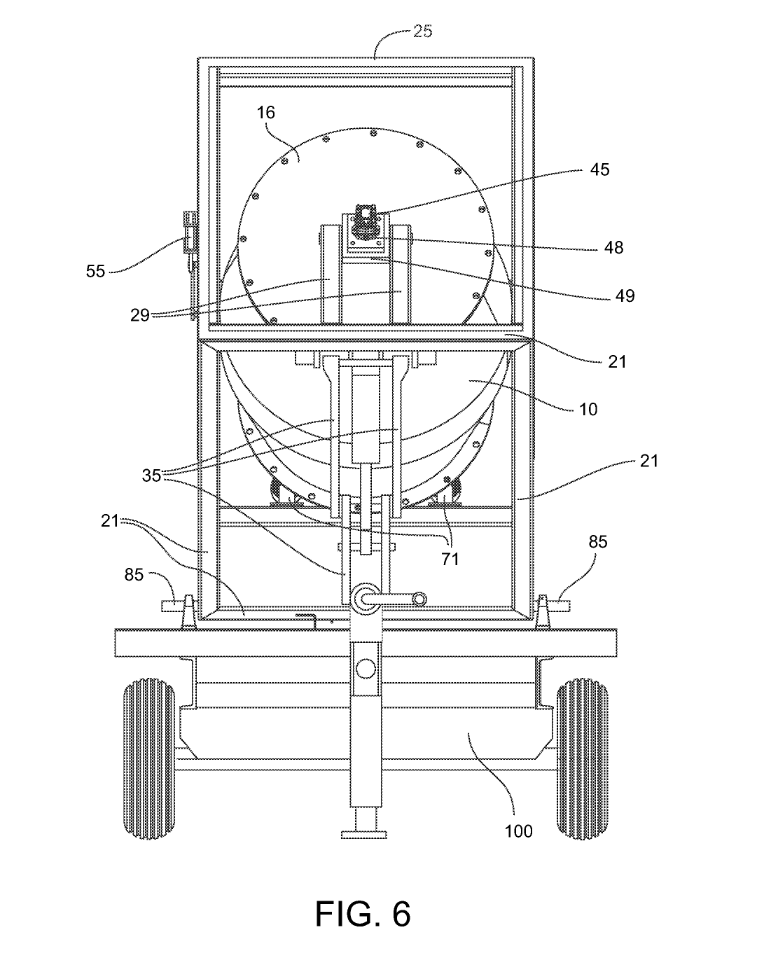

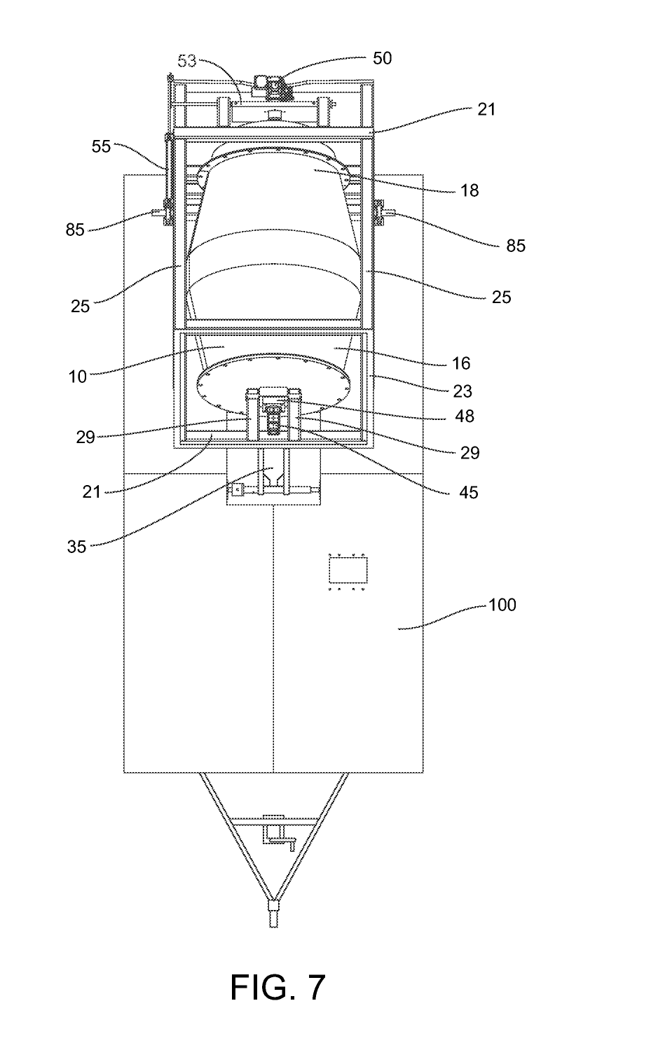

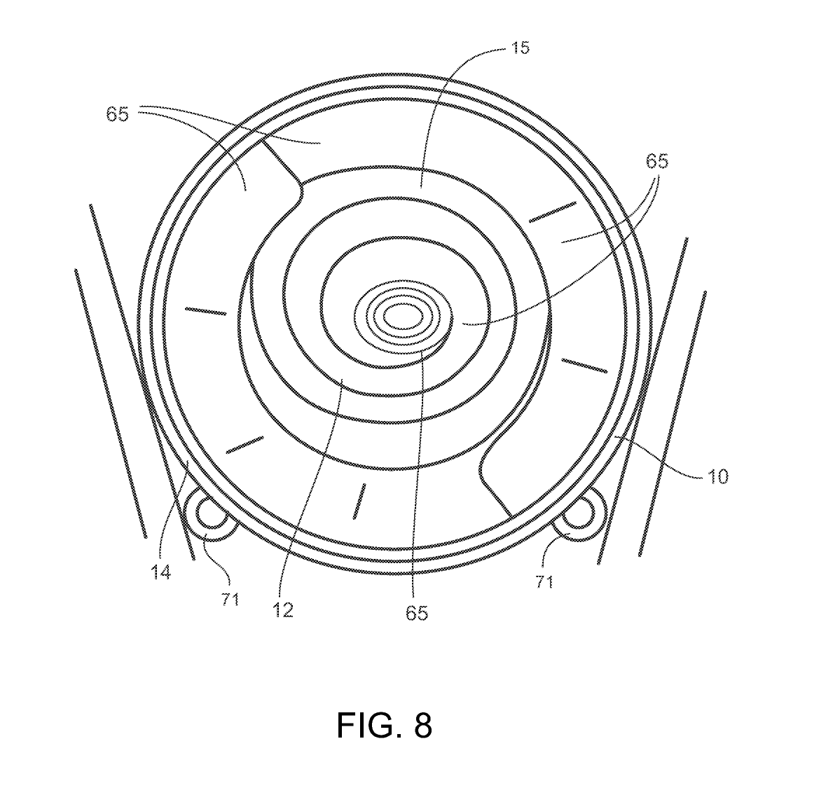

The base 20, as used herein, refers to the structural frame which holds the APR 5 in place and helps to maintain its stability both during transport and while in use. As illustrated in FIGS. 1 through 7, 9 and 10, the base includes a plurality of vertical frame members 23 secured to a plurality of horizontal frame members 25. Looking to FIGS. 1 and 2, there is illustrated an embodiment of the present invention wherein the base 20 includes four base frame members 21 which lie relatively flat on a trailer bed 100. There are 4 vertical frame members which emanate in a vertical direction upward from each of the four corners of the base frame 20. These include a pair of front vertical frame members 23 and a pair of rear vertical frame members 24. A horizontal frame member 25 is secured between each front vertical frame member 23 and rear vertical frame member 24. An upper horizontal frame member 26 is secured between the pair of rear vertical frame members 24 at their upper ends and a lower horizontal frame member 27 is also secured between the pair of rear vertical frame members 24 in the lower vicinity of each member as illustrated in FIGS. 1, 2, 3, 9 and 10. The base frame members 21 (which comprise the base), the front vertical frame members 23, the rear vertical frame members 24, the lateral horizontal frame members 25, the upper horizontal frame member 26 and the lower horizontal frame number 27 form a support structure or cage which surrounds the drum 10. The base 20 may further comprise a pair of drum support members 29 as illustrated in FIGS. 1, 2 and 6. The drum support members 29 help to provide support to the bearing plate 49, the gear box 48 and the hydraulic motor 45. In one embodiment the drum support members 29 engage with a pair of hinges which are secured to the gear box 48. Looking to FIGS. 1, 2, 3, 6, 9 and 10 there is illustrated an embodiment where in a pair of casters 71 is secured to the lower horizontal frame member 27. These casters 71 provide support to and allow the drum unit to rotate freely within the support structure. The casters 71 may be made of any material capable of supporting and permitting the rotational operation of the drum 10 such as steel.

The APR 5 is attached on a base 20 and is easily transportable due to economical size and weight and can be pulled from behind by a standard half-ton truck, or mounted on the bed of a heavy-duty truck. In one embodiment of the instant invention, the base 20 is a skid frame. A hitching mechanism allows the unit to be attached and detached from a vehicle transporting the machine. In one embodiment the APR 5 may be secured to a trailer 100 to allow for easy transport to and from the job site.

Unlike the APR 5, which is equipped with a self-controlled diesel generator 90 with the ability to run lights for night operations and to power an electric jackhammer or any other necessary equipment on site, existing machines failed to provide such accommodations. Additionally, to thoroughly mix material, previous machines have paddles, lifters, or flights. This is contrary to the APR 5 machine of the instant invention which features a steel rotating drum unit 10 with one or more corkscrew fins or baffle fins inside the drum unit 10. The drum 10 includes an inner shell 12, an outer shell 14, a front 16 and a rear 18 section.

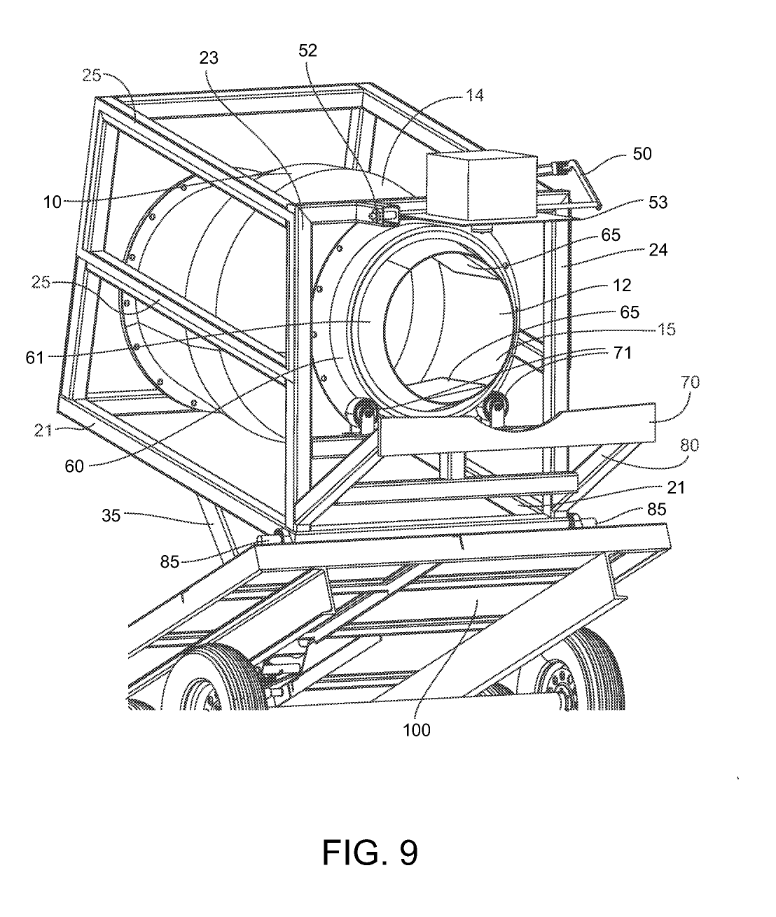

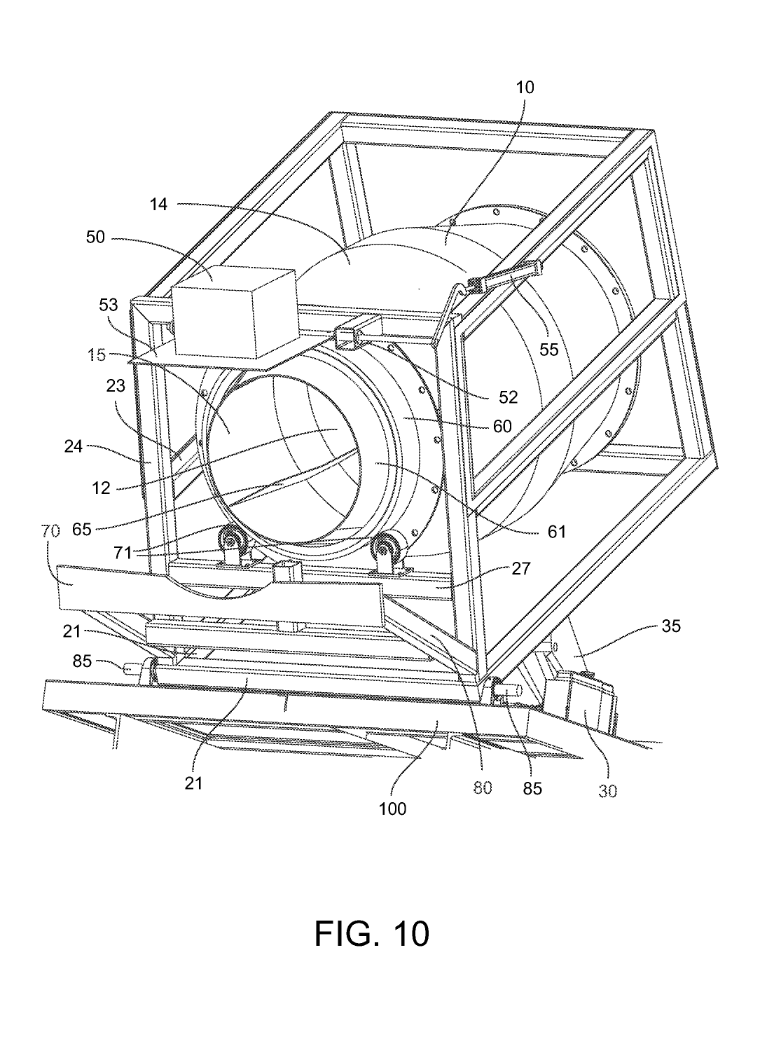

In one embodiment of the present invention, the APR 5 may feature a rotating drum unit 10 with two corkscrew fins 65 within the drum unit 10. In yet another embodiment, the APR 5 may feature a drum unit with a pair of corkscrew fins 65 which begin at the front 16 of the drum unit extend transversely to the rear 18 of the drum unit 10. In still another embodiment, the APR 5 may feature a drum unit 10 with two baffle fins 65 as illustrated in FIGS. 9 and 10. In another embodiment of the present invention, the corkscrew fins 65 may extend from the opening of the drum 10 to the back of the drum and have a length (as measured from the surface of the inner shell 12 where the fins are secured, extending inward to the center of the drum) in the range of 0.1 to 10 inches, 1 to 8 inches, 2-6 inches or 3-5 inches, depending on the size of the drum unit. The fins 65 create a circular motion inside the drum unit 10 that provides for complete mixing and pulls the material to be recycled or processed toward the burner at the rear 18 of the burner 50 within the drum unit. The fins 65 then are used to reverse direction (as well as the drum 10) to facilitate the discharge of the hot molten material (i.e. the material which was recycled/processed) mix back to the front 16 of the drum.

In one embodiment of the present invention, the drum 10 is a seven foot long, 3/16ths inch thick high grade double-plated and insulated (with two inches of eight-pound density mineral insulation) hardened and abrasive steel rotating drum operated on casters 71 (e.g. steel roller wheels). The inner shell 12 of the drum is ten gage abrasion resistant (AR) steel. The outer shell 14 is ten gage steel plate. Six inch casehardened steel dual corkscrew fins 65 in the inside of the rotating heating drum surface serve to facilitate not only the circular, tumbling and, cascading motion of the material through an even stream of hot air produced by the shielded burner flame in the mixing drum 10, but also, serve to pull the material toward the rear 18 of the heating drum for complete mixing and, then, reverse to discharge the material back to the front 16 of the drum for unloading. The asphalt is folded over to provide maximum heat at an even temperature throughout the process. Appropriate hydraulic connections (not illustrated) provide appropriate power for turning the drum 10.

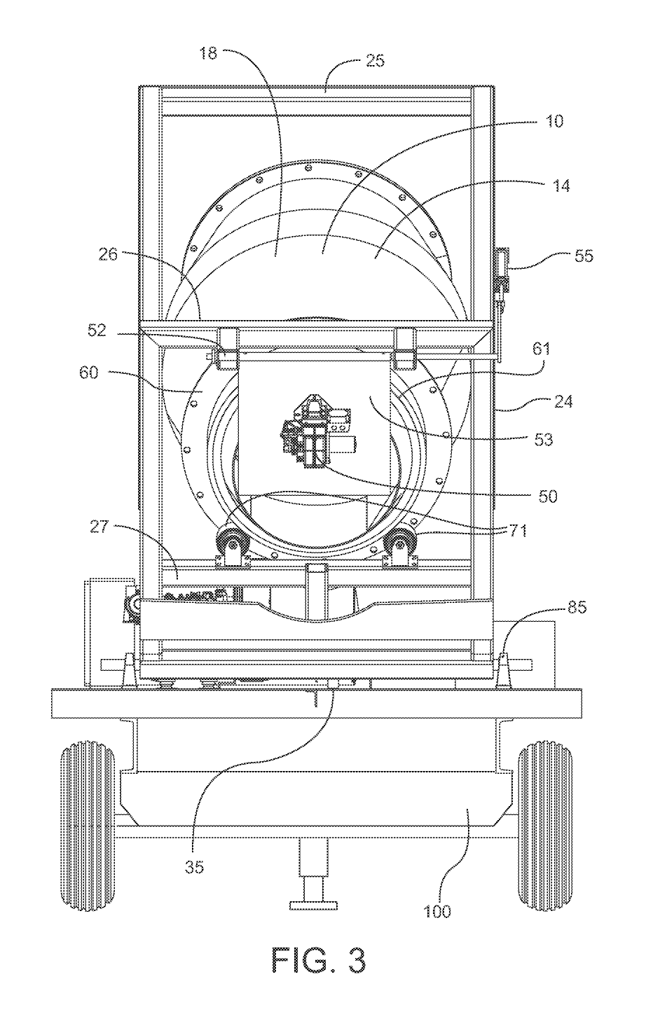

The drum 10 of the APR 5 may be mounted on or within the base frame member as illustrated in the Figures. The front 16 of the drum rests on a pair of drum support members 29 which is located near the hydraulic motor 45 the drum is angled downward at its front and is elevated at the rear 18. FIGS. 3, 9 and 10 illustrate the drum opening which is surrounded by a ring 61 and a collar of the drum 60. The coller of the drum 60 rotates with the aid of a pair of casters 71 which are secured to the lower horizontal frame number 27.

The instant invention may also employ a hopper (not illustrated). Hoppers are well known in the asphalt industry and may refer to a device or container which is used for holding, collecting and then loading material into the drum unit 10 of the APR 5. The hopper may be thought of as a symbol container which is used for pouring the material which is to be recycled/processed within the drum unit 10 of the APR 5, after which the hopper may be used to hold and transfer the material which has been recycled/processed after it is expelled from within the drum unit 10. The hopper may be used to temporarily store material either prior to being processed by the APR 5 or after having been processed by the APR 5. The hopper may be shaped in any configuration known in the art including, but not limited to, scoop shaped like a shovel, square, rectangular, round, or any combination thereof. In one embodiment of the instant invention, a loading trough 70 may be used as an alternative to or in addition to a hopper. The loading trough 70 refers to a device or container which is used for loading and unloading materials into and out of the drum unit 10 of the APR 5 in a manner similar to that described above for the hopper. The loading trough 70 may change positions to allow for the loading and unloading of the drum unit 10. In another embodiment of the instant invention, a vibratory shaker (not illustrated) may be added to the hopper or the loading trough 70 to accelerate the discharge of materials from either device.

The burner 50, as used herein refers to a device which heats the material which is to be recycled and/or processed. In one embodiment of the present invention, the burner will heat the asphalt material which is to be recycled or processed to a temperature which allows the asphalt material to be workable. The asphalt material may be heated to a temperature in the range of 50 to 250° C., 75 to 225° C., 100 to 200° C., 170 to 185° C. or 125 to 175° C. In one embodiment of the present invention, the burner is secured to a bracing structure located at the rear 18 of the drum unit 10 which directs a flame into the top one third of the rotatable drum unit. One very important feature of the instant invention is that the material which is to be recycled or processed within the rotatable drum unit 10 does not come into contact with a flame produced by the burner 50. In another embodiment, a burner 50 is mounted on the rear 18 of the mixing drum 10 opposite the loading hopper and collar 60 of the drum, where it will not obstruct the loading compartment of the heating drum. The burner flame is directed to the top ⅓rd of the drum 10 where it is heating only the vacant space in the drum 10 above the material to be recycled/processed which falls through the heated space to the base or front 16 of the rotating drum. This prevents the burner flame from burning or scorching the material inside the drum. In still another embodiment of the instant invention, the burner is powered by diesel fuel or gas and started by spark ignition from a battery.

As stated previously, the material in the drum 10 does not come into contact with the flame generated by the burner 50. The material is lifted by the circular corkscrew action of the drum 10 and fins 65 and it drops through the stream of hot air which is introduced from the burner 50 that directs a flame into the top one third portion of the drum 10. Also, the mixing action of the drum 10 greatly reduces the potential of overheating the product which could, otherwise, cause the material to ignite. The above features also facilitate the re-melting of the asphalt without driving off the more volatile light hydrocarbons in the asphalt and avoid the production of an undesirable dry crumbly result that leaves little of the original asphalt content (AC) oil intact in the asphalt. Looking to the Figures, one embodiment of the burner assembly is illustrated. The burner may include a heater cylinder 55 (secured to the lateral horizontal frame number 25 in FIG. 1) which is connected to the heater bushing 52 which is secured to the heater cover 53 and operably associated with the burner 50. The heater cylinder is hydraulic and functions to hydraulically open and close the heater cover 53. The burner 50 may have a heating capacity in the range of 500,000 to 850,000 BTU, 600,000 to 750,000 BTU, 650,000 to 700,000 BTU, or any combination thereof. In one embodiment of the present invention, the burner 50 may be a 700,000 BTU Beckett burner mounted on the rear of the drum 10. In another embodiment, the burner 50 may be a 750,000 BTU Beckett burner mounted on the rear of the drum 10.

The present invention provides a number of important technical advantages to the larger machines currently on the market. The APR 5 includes a thermostatic heating sensor device located within the rotatable drum unit 10 used to measure the temperature of the material to be recycled/processed from within the drum 10 while it is being heated. With the competitive machines the temperature is read from an infrared temperature sensor gun which must be partially placed into the mixing drum while the machine is running. This is especially dangerous if the agitator is engaged in these machines; and reading the temperature of the mix is not as convenient. A thermostatically controlled wireless pyrometer heating sensor controls the temperature of the mixing drum 10 and allows the operator to bring the mix to the desired temperature level. The thermostat controlled by the pyrometer also serves to prevent the material inside the drum from getting burned or scorched. Locating the heating sensor device within the drum is safer to the operators of the APR 5, more efficient because the heating cover 53 does not have to be displaced in order to obtain a temperature reading from within the drum 10 and also more efficient in providing accurate temperature readings to the operators of the APR 5 in knowing when the batch of material which is to be recycled/processed has achieved the desired temperature and may be expelled from within the drum 10 and replaced back into a roadway, parking lot or whatever location it is needed.

The APR 5 may further include a drum lift 35 which is operatively associated with the base 20 and/or base frame members 21 and makes use of the pivot joint 85 illustrated in FIGS. 1, 2, 4, 5, 6, 9 and 10. The drum lift 35 operates to raise the APR 5 by lifting the base frame on the front end of the drum 10 (as shown in the Figures). The drum lift may be secured at one end to the bed of a trailer 100 and to the base 20 at its opposite end. The pivot joint 85 remains stationary. This allows for the recycled/processed material to be more easily evacuated from within the drum 10 after recycling/processing is complete. The drum lift 35 may be operated mechanically, hydraulically or by a combination thereof.

In one embodiment of the instant invention, the APR 5 further comprises a water tank 110 operatively associated with the APR and a pump operatively associated with the water tank 110 to facilitate the preparation of concrete and to store the necessary releasing agent to allow for the removal of any mix residue from the interior of the drum 10 after using the APR 5 to prepare concrete. The water tank 110 may be secured to the base 20, to one or more base frame members 21 or 2 trailer 100. An additional storage tank or tanks 120 may also be operated only associated with the APR 5. These additional storage tanks 120 may store items such as hydraulic fluid, diesel fuel, releasing agent or any other material which may be required on the job site for the APR unit related to asphalt recycling/processing or concrete preparation and processing.

The APR 5 is not a large machine relative to most asphalt processing machines. To keep costs down the capacity of the APR 5 described herein is limited. In one embodiment, the APR 5 may have a capacity in the range of 100 to 10,000 pounds of asphalt material to be recycled/processed. In another embodiment the APR may have a capacity in the range of 100 to 8000 pounds of asphalt material to be recycled/processed. In still another embodiment the APR may have a capacity in the range of 100 to 5000 pounds of asphalt material to be recycled/processed. In yet another embodiment the APR may have a capacity in the range of 100 to 2000 pounds of asphalt material to be recycled/processed. In yet another embodiment the APR may have a capacity in the range of 100 to 1500 pounds of asphalt material to be recycled/processed.

In one embodiment, APR 5 will recycle 2-Tons of reclaimed asphalt pavement in the form of broken chunks up to 4000 pounds or millings (fine asphalt) every 20 minutes or less to produce usable hot mix asphalt for refilling and repairing potholes, making asphalt repairs for utility cuts and other small asphalt repairs and overlays. Put a different way, that means a new batch of reclaimed asphalt pavement weighing up to 4000 pounds may be loaded into, heated/processed with or without rejuvenating additives to a desired temperature and unloaded from the drum 10 of the APR 5 every 20 minutes. In another embodiment, APR 5 will recycle 1-Ton of reclaimed asphalt pavement in the form of broken chunks up to 2000 pounds or millings (fine asphalt) every 15 minutes or less to produce usable hot mix asphalt for refilling and repairing potholes, making asphalt repairs for utility cuts and other small asphalt repairs and overlays.

Production using milled material can be slower than chunk material if the milled material contains excessive moisture due to being piled outdoors without protection from the elements. Chunk material resists moisture invasion and, therefore, results in higher production. The APR 5 is not an asphalt re-claimer; it simply heats and recycles reclaimed asphalt pavement into hot usable asphalt in desired quantities. The goal is to produce a machine that provides cost savings, purchase justification and profitability. As stated previously, asphalt pavement recyclers eliminate the need to secure hot mix from the asphalt plant and allow the paver to utilize existing reclaimed broken, chunk or milled asphalt material already at the site of the needed repair to produce recycled hot asphalt mix at minimal cost. The end result of utilizing the APR 5, rather than other conventional procedures and methods of producing virgin asphalt paving mix is an immediate cost savings of $80 to $100 per ton, the cost of conventional asphalt from the plant.

The APR 5 further includes an operating panel (30) and control system which consists of three hydraulic controls which operate (1) drum charge and discharge, (2) drum lift 35, and (3) hopper lift/trough lift 80. The operating panel will also include water pump switch, temperature LED readout, engine start switch and emergency shut off.

In one embodiment of the instant invention, the operating panel 30 may include the following controls for the APR 5:
1. Control of the diesel-engine 90 via Keyed-Starter Switch.
2. Control of the diesel-engine 90 via Push button to stop.
3. RPM control of the diesel engine 90 via electronic control EC1, modifying the volume of diesel oil injected into the cylinders, indicator of actual speed, with buttons to increase respectively decrease the speed. RPM1 and RPM2. The EC1 has to be programmed in such a way as to never have the drum rotate at less than a set RPM in either direction. If the drum has to stop completely the diesel engine has to stop. The hydraulic pump for the barrel lifting and burner 50 movement (heater cylinder 55) is run from a battery, which is charged by the diesel engine 90. The capacity of the battery has to be determined by the number of movements of the barrel and/or the burner 50 with the drum 10 stopped.
4. RPM digital display.
5. Push button to lower the burner 50 (by operation of the heater cylinder 55) PH1. Push button to lift the burner 50 (by operation of the heater cylinder 55) PH2. The push button to lift the burner 50 takes the self-holding off the relay RH1, which maintains power to the single coil solenoid for lowering the burner 50. The flow of hydraulic oil to the heater cylinder 55 to lift the burner 50 has to be restricted so that the lifting speed is very slow. This way the burner 50 has turned off completely when the burner 50 direction leaves the opening of the drum 10.
6. Push button to switch on the burner 50 PH3. Push button to switch off burner 50 PH4. The push button to switch off the burner 50 takes the self-holding off the relay RH3, which switches on the burner 50. The limit switch LSH1 prevents the burner 50 from being started before the burner 50 is in the down position.
7. Push button to switch on the releasing agent pump PA1. Push button to switch off the releasing agent pump PA2 which is operationally associated with one of the storage tanks 120. The push button to switch off the agent takes the self-holding off the relay RA1, which switches on the releasing agent pump. The normally open contact EC1 C1 is closed when the diesel engine is started, contact controlled by the EC1 control board.
8. Push button to switch on the water pump PW1. Push button to switch off the water pump PW2. The push button to switch off the water pump takes the self-holding off the relay RW1, which switches on the water pump.
9. Push Button to lift barrel PB1. Push button to lower barrel PB2. The power goes to the double coil solenoid with center position open for recirculation, coil SB1 for lifting the drum 10, coil SB2 for lowering the drum. The piston in the solenoid valve is spring loaded so that it goes to the center position, when both coils are de-energized.
10. Emergency-stop button ES1 switches the power off to the operating panel 30, thus stopping every movement.

One of the larger prior art recycling machines mixes by rotating paddles inside the mixing drum. Like the APR, another has a rotating drum, but it is chain-driven, whereas the APR operates entirely off of hydraulics.

Unlike previous machines that perform a single task, the APR 5 is the only asphalt pavement recycling machine that offers the versatility of performing multiple tasks. In addition to recycling, processing and rejuvenating old pavement, the APR 5, also provides the capacity to produce concrete mix for repairs to sidewalks, curbs, gutters and other small concrete needs. In the field, it is often practical and necessary to be able to complete small concrete work that may become necessary along with asphalt repairs. At the job site, concrete curbing, sidewalks and catch basins in the immediate vicinity of the asphalt repairs often require reconstruction, as well as the adjacent asphalt surface needing repair. In fact, oftentimes, the repairs needed to asphalt are caused and required because of the repairs needed to the adjacent curbing, catch basins, etc. In the process of repairing the concrete structures, the surrounding asphalt must be removed or is damaged and requires repair subsequent to the reconstruction of the adjacent concrete infrastructure, returning to full utility all of the surrounding and supporting infrastructure in its original state. The APR 5 provides a solution to this need that none of the prior art asphalt pavement recyclers in the market are equipped to offer. The APR 5 provides a single machine at an affordable price that both recycles asphalt pavement and produces concrete.

The APR 5 has been produced in tandem with a companion pre-mix material which not only rejuvenates the old asphalt by restoring its oil content, bringing the asphalt binder content (the “AC content”) back to a premium grade and meeting or exceeding government regulated specifications, but provides additional qualities that improve the ultimate mix material and results in a more durable and longer-lasting repair. No prior art machine has a companion pre-mix available that is designed specifically to provide these benefits and, at the same time, reduce the price of the premix by as much as 50%. The instant invention makes this possible by incorporating ground asphalt shingles as an inexpensive source of asphalt cement, which generally is priced at $550 to $600 per ton in its conventional virgin liquid form in the current market. The dry, granular shingle product at equivalent capacity costs half as much as the liquid form of asphalt cement. The APR 5 companion pre-mix has this distinct pricing advantage which enables the paver to further reduce expenses. The savings to the user's budget is immediate.

This APR 5 machine and its companion pre-mix rejuvenate the product, which no other asphalt recycler has. The APR 5 also allows the paver to produce its own hot asphalt mix on site of needed asphalt repairs for basically no material cost by using the existing old pavement that is already there in the street rather than buying replacement asphalt from the asphalt plant. Old existing asphalt in the form of broken chunks is reprocessed within the APR drum 10 to a molten state and placed right back into the repair area from which it came. If the individual or team chooses to rejuvenate specifically the asphalt cement portion of the old pavement, which has depleted to some extent over time, he/she can add the optional rejuvenate pre-mix to provide a more durable and sustainable repair material. Adding the rejuvenate pre-mix to the process of converting the old pavement to new hot mix, containing millings, granular asphalt cement from discarded roofing shingles and crumb rubber from old vehicle tires results in a premium hot asphalt mix that is better than even conventional replacement asphalt from the hot plant. The asphalt cement content in the pre-mix restores life to the old pavement resulting in a premium grade asphalt binder. Rubber provides better adhesion, elasticity, movement and resilience. No conventional tack material is necessary because of the adhesive qualities of rubber. Rubber is crack and rut resistant, and provides better compaction and density thereby preventing penetration of moisture and damage to the sub-base beneath the repair. Rubber also protects against oxidation and deterioration. Together, with the APR machine and the pre-mix product, the cost of the repair is as economical as possible and the quality of the repair, due to the addition of the pre-mix, is superior to any other asphalt repair in the current market.

Although the prior art asphalt recycling machines produce larger quantities of hot mix and are appropriate for processing large stockpiles of reclaimed asphalt pavement for large paving jobs, as in paving large sections of highway, the APR, is more practical for patching and small asphalt repairs due to its smaller size and affordability.

In one embodiment of the present invention, old asphalt material, chunks up to 30 inches across, is loaded mechanically, or by hand, into a heavy gauge hydraulic loading hopper or loading trough 70 which is hinged at the bottom of the dump opening in the mixer/heat drum. After the material is loaded, the hopper or loading trough 70 is raised by a hydraulic cylinder, dumping the old asphalt material (and pre-mix rejuvenate, or any other additive, if desired) into the opening of the mixing drum 10. In one embodiment, the hopper may serve as a door to secure the material and contain the heat in the drum, the hopper is, then, closed against the drum opening 15.

After loading, the drum 10 begins to rotate on casters 71 (e.g. steel rollers) using gas or diesel powered hydraulics. The hydraulics are direct-driven and powered by a gas or diesel engine (e.g. a Honda 24 hp engine) with electric start mounted with an operating panel 30 at the side of the APR 5 in front of the drum 10. The hydraulics include a control handle for full control of forward and reverse capable of 8 RPMs. The drum may be capable of rotating at speeds of 2, 3, 4, 5, 6, 7, 8, 9, 10, 11 or 12 RPMs.

The motor/generator 90 drives a hydraulic pump and the pump powers a hydraulic motor which turns the rotating drum 10 and hopper cylinder mounted on the collar 60 at the bottom of the unit. The hydraulics are state-of-the-art and designed specifically for the APR 5 along with a high grade pump and gear box with speed controls and reverse drive for dumping out the hot material from within the drum 10.

The fully functional rotating drum 10 has a reverse discharge feature that facilitates the discharge of the hot mix once it has reached the appropriate temperature and facilitates cleaning out the drum at the end of the day's use. When the recycled hot mix reaches the desired temperature, a hydraulic lift 35 raises the entire load for easy unloading directly into a waiting asphalt application.

Large outer doors (not illustrated) may be located on either side of the APR make the heating drum, hydraulics and other components easily accessible. The APR 5 is attached to a main frame 20 with two axles and four wheels with electrical breaks for easy transportability. The unit incorporates a hitch assembly that allows the unit to be attached to and removed from a truck or tractor pulling the unit in a trailer configuration.

The design and engineering of the APR dictates manufacturing for lifelong quality and easy maintenance. There are no complicated parts that make repairs expensive or that will cause excessive down time.

The APR 5 allows the user to change the recipe to fit the application of the current weather conditions. The APR 5 allows otherwise discarded and waste asphalt paving to be converted into useable working material. The APR 5 recycles cost effectively year around in good or bad weather. Even in cold or wet weather conditions, the APR 5 is able to transform a load of reclaimed asphalt pavement or millings into usable hot asphalt at the desired temperature within 15 minutes. If desired, the rejuvenating additive or pre-mix is placed in the mixing drum 10 with the reclaimed asphalt pavement and processed together to restore the oil content of the old asphalt pavement material and the rejuvenate, with rubber component, imparts additional advantages which prolong the life of the repair. As indicated previously, a distinguishing feature of the APR unit 5 is its ability to produce concrete. None of the competitive asphalt pavement recycling machines have this option or versatility. The APR unit will be equipped with a 50 gallon water tank 110 and pump to facilitate the preparation of the concrete mix and to store the necessary releasing agent to allow the paver to remove the mix residue from the interior of the mixing drum 10 at the end of daily use.

The instant invention also includes a method of preparing and/or processing asphalt and recycled asphalt for use comprising the steps of:

(a) arriving at a location where material is available for reusing or recycling;

(b) positioning a portable asphalt pavement recycling device (APR) 5 near the location, where the APR 5 comprises:

a base 20, a rotatable drum unit 10 rotatably secured to the base, a hopper or a trough 70 secured to the base or the rotatable drum unit 10 used to load materials (i.e. used and/or new asphalt pavement) into the rotatable drum unit 10 to be processed and used to unload materials which have been processed from within the rotatable drum unit 10, a burner 50 secured to the rear 18 of the rotatable drum unit 10 which is used to heat the materials which are to be recycled. The instant invention also includes one or more fins 65 located within the rotatable drum unit 10, where the fins are operable in the mixing and folding of the material to be recycled/processed and also being operable in pulling the material to be recycled/processed to the rear 18 of the rotatable drum unit for complete heating and mixing and pushing the recycled/processed material from the rear 18 of the rotatable drum unit 10 to the front 16 of the drum unit 10 for unloading, wherein the material within the rotatable drum unit 10 does not come into contact with a flame produced by the burner 50 and a thermostatic heating sensor device located within the rotatable drum unit used to measure the temperature of the material to be recycled while it is being recycled;

(c) retrieving and collecting the materials which are to be recycled/processed;

(d) loading the materials which are to be recycled/processed onto/into the hopper;

(e) raising the hopper and dumping the materials which are to be recycled/processed into the rotatable drum unit;

(f) turning on the burner and turning on the drum unit rotator in order to heat and mix the materials which are to be recycled/processed;

(g) heating and mixing the materials which are to be recycled/processed to a desired temperature and/or consistency resulting in a recycled/rejuvenated material;

(h) unloading said recycled/processed material from within said rotatable drum unit onto/into said hopper;

(i) lowering the hopper to gain access to said recycled/processed material; place the recycled/processed material in a desired location; and

(j) compacting the recycled/processed material resulting in asphalt cement.

In one embodiment, the above method further comprises the step of adding a companion pre-mix material to either the hopper, loading trough 70 or the drum unit 10 prior to heating up the materials which are to be recycled/processed.

Regarding the above method, the burner 50 may be secured to a bracing structure located at the rear 18 of the rotatable drum unit 10 which directs a flame into the top ⅓ of the rotatable drum unit 10. Additionally, the device of the above methods also has the ability to produce concrete. The device in the above method may further comprise a water tank secured to the base and a pump operatively associated with the water tank to facilitate the preparation of concrete and to store the necessary releasing agent to allow for the removal of any mix residue from the interior of the rotatable drum unit 10 after use.

Regarding the above method, the base 20, as used herein, refers to the structural frame which holds the APR 5 in place and helps to maintain its stability both during transport and while in use. As illustrated in FIGS. 1 through 7, 9 and 10, the base includes a plurality of vertical frame members 23 secured to a plurality of horizontal frame members 25. Looking to FIGS. 1 and 2, there is illustrated an embodiment of the present invention wherein the base 20 includes four base frame members 21 which lie relatively flat on a trailer bed 100. There are 4 vertical frame members which emanate in a vertical direction upward from each of the four corners of the base frame 20. These include a pair of front vertical frame members 23 and a pair of rear vertical frame members 24. A horizontal frame member 25 is secured between each front vertical frame member 23 and rear vertical frame member 24. An upper horizontal frame member 26 is secured between the pair of rear vertical frame members 24 at their upper ends and a lower horizontal frame member 27 is also secured between the pair of rear vertical frame members 24 in the lower vicinity of each member as illustrated in FIGS. 1, 2, 3, 9 and 10. The base frame members 21 (which comprise the base), the front vertical frame members 23, the rear vertical frame members 24, the lateral horizontal frame members 25, the upper horizontal frame member 26 and the lower horizontal frame number 27 form a support structure or cage which surrounds the drum 10. The base 20 may further comprise a pair of drum support members 29 as illustrated in FIGS. 1, 2 and 6. The drum support members 29 help to provide support to the bearing plate 49, the gear box 48 and the hydraulic motor 45. In one embodiment the drum support members 29 engage with a pair of hinges which are secured to the gear box 48. Looking to FIGS. 1, 2, 3, 6, 9 and 10 there is illustrated an embodiment where in a pair of casters 72 is secured to the lower horizontal frame member 27. These casters 71 provide support to the drum unit 10 and allow the drum unit to rotate freely within the support structure.

Regarding the above method, the APR 5 is attached on a base 20 and is easily transportable due to economical size and weight and can be pulled from behind by a standard half-ton truck, or mounted on the bed of a heavy-duty truck. In one embodiment of the instant invention, the base 20 is a skid frame. A hitching mechanism allows the unit to be attached and detached from a vehicle transporting the machine. In one embodiment the APR 5 may be secured to a trailer 100 to allow for easy transport to and from the job site.

Regarding the above method, unlike the APR 5, which is equipped with a self-controlled diesel generator 90 with the ability to run lights for night operations and to power an electric jackhammer or any other necessary equipment on site, existing machines failed to provide such accommodations. Additionally, to thoroughly mix material, previous machines have paddles, lifters, or flights. This is contrary to the APR 5 machine of the instant invention which features a steel rotating drum unit 10 with one or more corkscrew fins 65 inside the drum unit 10. The drum 10 includes an inner shell 12, an outer shell 14, a front 16 and a rear 18 section.

Regarding the above method, in one embodiment of the present invention, the APR 5 may feature a rotating drum unit 10 with two corkscrew fins 65 within the drum unit 10. In yet another embodiment, the APR 5 may feature a drum unit with a pair of corkscrew fins 65 which begin at the front 16 of the drum unit extend transversely to the rear 18 of the drum unit 10. In still another embodiment, the APR 5 may feature a drum unit 10 with two baffle fins 65 as illustrated in FIGS. 9 and 10. In another embodiment of the present invention, the corkscrew fins 65 may extend from the opening of the drum 10 to the back of the drum and have a length (as measured from the surface of the inner shell 12 where the fins are secured, extending inward to the center of the drum) in the range of 0.1 to 10 inches, 1 to 8 inches, 2-6 inches or 3-5 inches, depending on the size of the drum unit. The fins 65 create a circular motion inside the drum unit 10 that provides for complete mixing and pulls the material to be recycled or processed toward the burner at the rear 18 of the burner 50 within the drum unit. The fins 65 then are used to reverse direction (as well as the drum 10) to facilitate the discharge of the hot molten material (i.e. the material which was recycled/processed) mix back to the front 16 of the drum.

Regarding the above method, in one embodiment of the present invention, the drum 10 is a seven foot long, 3/16ths inch thick high grade double-plated and insulated (with two inches of eight-pound density mineral insulation) hardened and abrasive steel rotating drum operated on casters 71 (e.g. steel roller wheels). The inner shell 12 of the drum is ten gage abrasion resistant (AR) steel. The outer shell 14 is ten gage steel plate. Six inch casehardened steel dual corkscrew fins 65 in the inside of the rotating heating drum surface serve to facilitate not only the circular, tumbling and, cascading motion of the material through an even stream of hot air produced by the shielded burner flame in the mixing drum 10, but also, serve to pull the material toward the rear 18 of the heating drum for complete mixing and, then, reverse to discharge the material back to the front 16 of the drum for unloading. The asphalt is folded over to provide maximum heat at an even temperature throughout the process. Appropriate hydraulic connections (not illustrated) provide appropriate power for turning the drum 10.

Regarding the above method, the drum 10 of the APR 5 may be mounted on or within the base frame member as illustrated in the Figures. The front 16 of the drum rests on a pair of drum support members which is located near the hydraulic motor 45 the drum is angled downward at its front and is elevated at the rear 18. FIGS. 3, 9 and 10 illustrate the drum opening which is surrounded by a ring 61 and a collar of the drum 60. The caller of the drum 60 rotates with the aid of a pair of casters 71 which are secured to the lower horizontal frame number 27.

Regarding the above method, the instant invention may also employ a hopper (not illustrated). Hoppers are well known in the asphalt industry and may refer to a device or container which is used for holding, collecting and then loading material into the drum unit 10 of the APR 5. The hopper may be thought of as a symbol container which is used for pouring the material which is to be recycled/processed within the drum unit 10 of the APR 5, after which the hopper may be used to hold and transfer the material which has been recycled/processed after it is expelled from within the drum unit 10. The hopper may be used to temporarily store material either prior to being processed by the APR 5 or after having been processed by the APR 5. The hopper may be shaped in any configuration known in the art including, but not limited to, scoop shaped like a shovel, square, rectangular, round, or any combination thereof. In one embodiment of the instant invention, a loading trough 70 may be used as an alternative to or in addition to a hopper. The loading trough 70 refers to a device or container which is used for loading and unloading materials into and out of the drum unit 10 of the APR 5 in a manner similar to that described above for the hopper. The loading trough 70 may change positions to allow for the loading and unloading of the drum unit 10. In another embodiment of the instant invention, a vibratory shaker (not illustrated) may be added to the hopper or the loading trough 70 to accelerate the discharge of materials from either device.

Regarding the above method, the burner 50, as used herein refers to a device which heats the material which is to be recycled and/or processed. In one embodiment of the present invention, the burner will heat the asphalt material which is to be recycled or processed to a temperature which allows the asphalt material to be workable. The asphalt material may be heated to a temperature in the range of 50 to 250° C., 75 to 225° C., 100 to 200° C., 170 to 185° C. or 125 to 175° C. In one embodiment of the present invention, the burner is secured to a bracing structure located at the rear 18 of the drum unit 10 which directs a flame into the top one third of the rotatable drum unit. One very important feature of the instant invention is that the material which is to be recycled or processed within the rotatable drum unit 10 does not come into contact with a flame produced by the burner 50. In another embodiment, a burner 50 is mounted on the rear 18 of the mixing drum 10 opposite the loading hopper and collar 60 of the drum, where it will not obstruct the loading compartment of the heating drum. The burner flame is directed to the top ⅓rd of the drum 10 where it is heating only the vacant space in the drum 10 above the material to be recycled/processed which falls to the base or front 16 of the rotating drum. This prevents the burner from burning or scorching the material inside the drum. In still another embodiment of the instant invention, the burner is powered by diesel fuel or gas and started by spark ignition from a battery.

Regarding the above method, the material in the drum 10 does not come into contact with the flame generated by the burner 50. The material is lifted by the circular corkscrew action of the drum 10 and fins 65 and it drops through the stream of hot air which is introduced from the burner 50 that directs a flame into the top one third portion of the drum 10. Also, the mixing action of the drum 10 greatly reduces the potential of overheating the product which could, otherwise, cause the material to ignite. The above features also facilitate the re-melting of the asphalt without driving off the more volatile light hydrocarbons in the asphalt and avoid the production of an undesirable dry crumbly result that leaves little of the original asphalt content (AC) oil intact in the asphalt. Looking to the Figures, one embodiment of the burner assembly is illustrated. The burner may include a heater cylinder 55 (secured to the lateral horizontal frame number 25 in FIG. 1) which is connected to the heater bushing 52 which is secured to the heater cover 53 and operably associated with the burner 50. The burner 50 may have a heating capacity in the range of 500,000 to 850,000 BTU, 600,000 to 750,000 BTU, 650,000 to 700,000 BTU, or any combination thereof. In one embodiment of the present invention, the burner 50 may be a 700,000 BTU Beckett burner mounted on the rear of the drum 10. In another embodiment, the burner 50 may be a 750,000 BTU Beckett burner mounted on the rear of the drum 10.

Regarding the above method, the present invention provides a number of important technical advantages to the larger machines currently on the market. The APR 5 includes a thermostatic heating sensor device located within the rotatable drum unit 10 used to measure the temperature of the material to be recycled/processed from within the drum 10 while it is being heated. With the competitive machines the temperature is read from an infrared temperature sensor gun which must be partially placed into the mixing drum while the machine is running. This is especially dangerous if the agitator is engaged in these machines; and reading the temperature of the mix is not as convenient. A thermostatically controlled wireless pyrometer heating sensor controls the temperature of the mixing drum 10 and allows the operator to bring the mix to the desired temperature level. The thermostat controlled by the pyrometer also serves to prevent the material inside the drum from getting burned or scorched. Locating the heating sensor device within the drum is safer to the operators of the APR 5, more efficient because the heating cover 53 does not have to be displaced in order to obtain a temperature reading from within the drum 10 and also more efficient in providing accurate temperature readings to the operators of the APR 5 in knowing when the batch of material which is to be recycled/processed has achieved the desired temperature and may be expelled from within the drum 10 and replaced back into a roadway, parking lot or whatever location it is needed.

Regarding the above method, the APR 5 may further include a drum lift 35 which is operatively associated with the base 20 and/or base frame members 21 and makes use of the pivot joint 85 illustrated in FIGS. 1, 2, 4, 5, 6, 9 and 10. The drum lift 35 operates to raise the APR 5 by lifting the base frame on the front end of the drum 10 (as shown in the Figures). The drum lift may be secured at one end to the bed of a trailer 100 and to the base 20 at its opposite end. The pivot joint 85 remain stationary. This allows for the recycled/processed material to be more easily evacuated from within the drum 10 after recycling/processing is complete. The drum lift 35 may be operated mechanically, hydraulically or by a combination thereof.

Regarding the above method, in one embodiment of the instant invention, the APR 5 further comprises a water tank 110 operatively associated with the APR and a pump operatively associated with the water tank 110 to facilitate the preparation of concrete and to store the necessary releasing agent to allow for the removal of any mix residue from the interior of the drum 10 after using the APR 5 to prepare concrete. The water tank 110 may be secured to the base 20, to one or more base frame members 21 or 2 trailer 100. An additional storage tank or tanks 120 may also be operated only associated with the APR 5. These additional storage tanks 120 may store items such as hydraulic fluid, diesel fuel, releasing agent or any other material which may be required on the job site for the APR unit related to asphalt recycling/processing or concrete preparation and processing.

Regarding the above method, the APR 5 is not a large machine relative to most asphalt processing machines. To keep costs down the capacity of the APR 5 described herein is limited. In one embodiment, the APR 5 may have a capacity in the range of 100 to 10,000 pounds of asphalt material to be recycled/processed. In another embodiment the APR may have a capacity in the range of 100 to 8000 pounds of asphalt material to be recycled/processed. In still another embodiment the APR may have a capacity in the range of 100 to 5000 pounds of asphalt material to be recycled/processed. In yet another embodiment the APR may have a capacity in the range of 100 to 2000 pounds of asphalt material to be recycled/processed. In yet another embodiment the APR may have a capacity in the range of 100 to 1500 pounds of asphalt material to be recycled/processed.

Regarding the above method, the in one embodiment, APR 5 will recycle 2-Tons of reclaimed asphalt pavement in the form of broken chunks up to 4000 pounds or millings (fine asphalt) every 20 minutes or less to produce usable hot mix asphalt for refilling and repairing potholes, making asphalt repairs for utility cuts and other small asphalt repairs and overlays. Put a different way, that means a new batch of reclaimed asphalt pavement weighing up to 4000 pounds may be loaded into, heated/processed with or without rejuvenating additives to a desired temperature and unloaded from the drum 10 of the APR 5 every 20 minutes. In another embodiment, APR 5 will recycle 1-Ton of reclaimed asphalt pavement in the form of broken chunks up to 2000 pounds or millings (fine asphalt) every 15 minutes or less to produce usable hot mix asphalt for refilling and repairing potholes, making asphalt repairs for utility cuts and other small asphalt repairs and overlays.

Production using milled material can be slower than chunk material if the milled material contains excessive moisture due to being piled outdoors without protection from the elements. Chunk material resists moisture invasion and, therefore, results in higher production. The APR 5 is not an asphalt re-claimer; it simply heats and recycles reclaimed asphalt pavement into hot usable asphalt in desired quantities. The goal is to produce a machine that provides cost savings, purchase justification and profitability. As stated previously, asphalt pavement recyclers eliminate the need to secure hot mix from the asphalt plant and allow the paver to utilize existing reclaimed broken, chunk or milled asphalt material already at the site of the needed repair to produce recycled hot asphalt mix at minimal cost. The end result of utilizing the APR 5, rather than other conventional procedures and methods of producing virgin asphalt paving mix is an immediate cost savings of $80 to $100 per ton, the cost of conventional asphalt from the plant.

Regarding the above method, the APR 5 further includes an operating panel 30 and control system which consists of three hydraulic controls which operate (1) drum charge and discharge, (2) drum lift 35, and (3) hopper lift 80. The operating panel will also include water pump switch, temperature LED readout, engine start switch and emergency shut off.

Regarding the above method, one of the larger prior art recycling machines mixes by rotating paddles inside the mixing drum. Like the APR, another has a rotating drum, but it is chain-driven, whereas the APR operates entirely off of hydraulics. The above methods may incorporate any and all items and processes described within this specification.

The present invention may be embodied in other forms without departing from the spirit and the essential attributes thereof, and, accordingly, reference should be made to the appended claims, rather than to the foregoing specification, as indicating the scope of the invention. The invention illustratively discloses herein suitably may be practiced in the absence of any element which is not specifically disclosed herein.

I claim:

1. A portable asphalt pavement recycling device comprising:
a base;
a rotatable drum unit rotatably secured to the base;
a hopper secured to the base or the rotatable drum unit used to load materials into the rotatable drum unit to be recycled/processed and used to unload materials which have been recycled/processed from within the rotatable drum unit;
a burner secured to the rear of the rotatable drum unit which is used to heat the materials which are to be recycled/processed;
one or more fins located within the rotatable drum unit, the fins being operable in the mixing and folding of the material to be recycled/processed and also being operable in:
pulling the material to be recycled/processed to the rear of the rotatable drum unit for complete heating and mixing and
pushing the recycled/processed material from the rear of the rotatable drum unit to the front of the drum unit for unloading;
wherein the material within the rotatable drum unit does not come into contact with a flame produced by the burner; and
a thermostatic heating sensor device located within the rotatable drum unit used to measure the temperature of the material to be recycled/processed while it is being recycled/processed.

2. The portable asphalt recycling device of claim 1 wherein said burner being secured to a bracing structure located at the rear of the rotatable drum unit which directs a flame into the top ⅓ of the rotatable drum unit.

3. The portable asphalt recycling device of claim 1 wherein said device also having the ability to produce concrete.

4. The portable asphalt recycling device of claim 3 further comprising:
a water tank secured to said base;
a pump operatively associated with said water tank to facilitate the preparation of the concrete and to store the necessary releasing agent to allow for the removal of any mix residue from the interior of the rotatable drum unit after use.

5. The portable asphalt recycling device of claim 1 wherein said device having a capacity in the range of 1000 to 10000 pounds of material to be processed.

6. The portable asphalt recycling device of claim 1 wherein said device having the capability of processing 2000 pounds of recyclable material in 15 minutes or less.

7. The portable asphalt recycling device of claim 1 wherein said rotatable drum unit being mechanically rotated by a hydraulic drive.

8. The portable asphalt recycling device of claim 1 wherein said fin is one continuous structure which lines the inside of said rotatable drum unit beginning at a mouth of said drum unit and continuing all the way to a back of said drum unit.

9. The portable asphalt recycling device of claim 1 wherein said fin being selected from the group consisting of: a corkscrew fin, a baffle, or a combination thereof, said fin extending transversely into said rotatable drum unit for mixing and directing materials which are to be recycled.

10. A method of preparing asphalt and recycled asphalt for use comprising the steps of:
arriving at a location where material is available for reusing or recycling;
positioning a portable asphalt pavement recycling device near said location, said portable asphalt pavement recycling device comprising:
a base;
a rotatable drum unit rotatably secured to the base;
a hopper secured to the base or the rotatable drum unit used to load materials into the rotatable drum unit to be recycled/processed and used to unload materials which have been recycled/processed from within the rotatable drum unit;
a burner secured to the rear of the rotatable drum unit which is used to heat the materials which are to be recycled/processed;
one or more fins located within the rotatable drum unit, the fins being operable in the mixing and folding of the material to be recycled/processed and also being operable in:
pulling the material to be recycled to the back of the rotatable drum unit for complete heating and mixing and
pushing the recycled/processed material from the back of the rotatable drum unit to the front of the drum unit for unloading;
wherein the material within the rotatable drum unit does not come into contact with a flame produced by the burner; and
a thermostatic heating sensor device located within the rotatable drum unit used to measure the temperature of the material to be recycled/processed while it is being recycled and or rejuvenated;
retrieving and collecting the materials which are to be recycled/processed;
loading the materials which are to be recycled/processed onto/into the hopper;
raising the hopper and dumping the materials which are to be recycled/processed into the rotatable drum unit;
turning on the burner and turning on the drum unit rotator in order to heat and mix the materials which are to be recycled/processed;
heating and mixing the materials which are to be recycled/processed to a desired temperature and/or consistency resulting in a recycled/rejuvenated material;
unloading said recycled/processed material from within said rotatable drum unit onto/into said hopper;
lowering the hopper to gain access to said recycled/processed material;
place the recycled/processed material in a desired location; and
compacting the recycled/processed material resulting in asphalt cement.

11. The method of claim 10 further comprising the step of adding a companion pre-mix material to either the hopper or the drum unit prior to heating up the materials which are to be recycled.

12. The method of claim 10 wherein said burner being secured to a bracing structure located at the rear of the rotatable drum unit which directs a flame into the top ⅓ of the rotatable drum unit.

13. The method of claim 10 wherein said device also having the ability to produce concrete.

14. The method of claim 13 further comprising:
a water tank secured to said base;
a pump operatively associated with said water tank to facilitate the preparation of the concrete and to store the necessary releasing agent to allow for the removal of any mix residue from the interior of the rotatable drum unit after use.

15. The method of claim 10 wherein said device having a capacity in the range of 1000 to 10000 pounds of material to be processed.

16. The method of claim 10 wherein said device having the capability of processing 2000 pounds of recyclable material in 15 minutes or less.

17. The method of claim 10 wherein said rotatable drum unit being mechanically rotated by a hydraulic drive.

18. The method of claim 10 wherein said fin is one continuous structure which lines the inside of said rotatable drum unit beginning at a mouth of said drum unit and continuing all the way to a back of said drum unit.

19. The method of claim 10 wherein said fin being selected from the group consisting of: a corkscrew fin, a baffle, or a combination thereof, said fin extending transversely into said rotatable drum unit for mixing and directing materials which are to be recycled.
